(19) United States
(12) Patent Application Publication
(10) Pub. No.: US 2022/0138458 A1
(43) Pub. Date: May 5, 2022

(54) ESTIMATION DEVICE, ESTIMATION SYSTEM, ESTIMATION METHOD AND PROGRAM

(71) Applicant: KABUSHIKI KAISHA TOSHIBA, Tokyo (JP)

(72) Inventor: Tomoyuki SHIBATA, Kawasaki (JP)

(73) Assignee: KABUSHIKI KAISHA TOSHIBA, Tokyo (JP)

(21) Appl. No.: 17/504,991

(22) Filed: Oct. 19, 2021

(30) Foreign Application Priority Data
Oct. 30, 2020 (JP) 2020-182699

(51) Int. Cl. G06K 9/00; G06T 7/73

(52) U.S. Cl. CPC G06K 9/00342; G06T 2207/10016; G06T 2207/30196; G06T 7/73

(57) ABSTRACT

An estimation device including an imager, a detection unit, and an estimation unit. The imager captures an image including a subject. The detection unit detects skeleton information including a first feature point indicating the skeleton of the subject from the image. The estimation unit estimates an action of the subject by determining a position of the first feature point in a rectangle including the subject as a first threshold value based on an installation position of the imager and an imaging range of the imager.

### CROSS-REFERENCE TO RELATED APPLICATIONS

This application is based upon and claims the benefit of priority from Japanese Patent Application No. 2020-182699, filed Oct. 30, 2020, the entire contents of which are incorporated herein by reference. Any and all applications for which a foreign or domestic priority claim is identified in the Application Data Sheet as filed with the present application are hereby incorporated by reference under 37 CFR 1.57.

### BACKGROUND

### Field

Embodiments described herein relate generally to an estimation device, an estimation system, an estimation method, and a program.

### SUMMARY

In general, according to one embodiment, an estimation device includes an imager, a detection unit, and an estimation unit. The imager captures an image including a subject. The detection unit detects skeleton information including a first feature point indicating the skeleton of the subject from the image. The estimation unit estimates an action of the subject by determining a position of the first feature point in a rectangle including the subject as a first threshold value based on an installation position of the image capturing unit and an imaging range of the image capturing unit.

### BRIEF DESCRIPTION OF THE DRAWINGS

FIG. 1 is a view showing an example of a functional configuration of an estimation device of an embodiment.

FIG. 2A is a view showing an Example 1 of a specific action of the embodiment.

FIG. 2B is a view showing an Example 2 of a specific action of the embodiment.

FIG. 2C is a view showing an Example 3 of a specific action of the embodiment.

FIG. 2D is a view showing an Example 4 of a specific action of the embodiment.

FIG. 2E is a view showing an Example 5 of a specific action of the embodiment.

FIG. 3 is a view showing an example of a coordinate system converted by a conversion unit of the embodiment.

FIG. 4 is a view showing an example of a person in an upright posture, a person collapsing in the direction of the camera, and a person collapsing in the opposite direction of the camera.

FIG. 5 is a view showing an example of an image of a squatting person captured by camera.

FIG. 6 is a view showing an example (in a case of knees positions) of key feature to points used for estimation of the embodiment.

FIG. 7 is a view showing Example 1 (in a case of an upright posture) of a ratio of a length from y=0 to the position of the y-coordinate of a knee to a length of the entire y-axis of the embodiment.

FIG. 8 is a view showing Example 2 (in a case of a squat) of a ratio of a length from y=0 to the position of the y-coordinate of a knee to a length of the entire y-axis of the embodiment.

FIG. 9A is a view showing Example 3 (in a case of a crouch) of a ratio of a length from y=0 to the position of the y-coordinate of a knee to a length of the entire y-axis of the embodiment.

FIG. 9B is a view showing Example 4 (in a case of a crouch) of a ratio of a length from y=0 to the position of the y-coordinate of a knee to a length of the entire y-axis of the embodiment.

FIG. 9C is a view showing Example 5 (in a case of a crouch) of a ratio of a length from y=0 to the position of the y-coordinate of a knee to a length of the entire y-axis of the embodiment.

FIG. 10 is a view showing Example 6 (in a case of a collapse) of a ratio of a length from y=0 to the position of the y-coordinate of a knee to a length of the entire y-axis of the embodiment.

FIG. 11 is a flowchart showing an example of an estimation method of the embodiment.

FIG. 12 is a view showing an example of a functional configuration of an estimation device of a modification example of the embodiment.

FIG. 13 is a view showing an example of a hardware configuration of the estimation device of the embodiment.

### DETAILED DESCRIPTION OF PREFERRED EMBODIMENTS

A method for estimating an action of a subject such as a person using skeleton information on the subject such as the person is known in background art. For example, an estimation method based on a time-series change of a two-dimensional coordinate sequence on an image is known in background art. Furthermore, for example, an estimation method based on a three-dimensional coordinate sequence of a skeleton acquired by using a sensor capable of acquiring a depth is known in background art.

An example of background art includes Japanese Patent No. 6525179.

However, with the background art, it is difficult to estimate an action of a subject from less information such as only a still image.

In general, according to one embodiment, there is provided an estimation device including an imager, a detection unit, and an estimation unit. The image capturing unit captures an image including a subject. The detection unit detects skeleton information including a first feature point indicating the skeleton of the subject from the image. The estimation unit estimates an action of the subject by determining a position of the first feature point in a rectangle including the subject as a first threshold value based on an installation position of the image capturing unit and an imaging range of the image capturing unit.

An embodiment of an estimation device, an estimation system, an estimation method, and a program will be described below in detail with reference to the accompanying drawings.

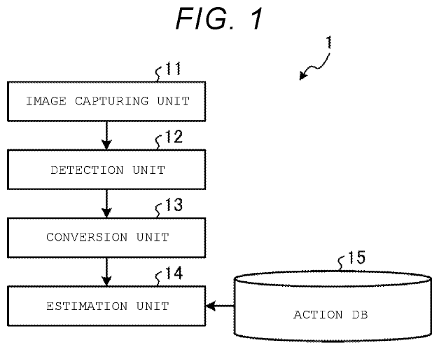

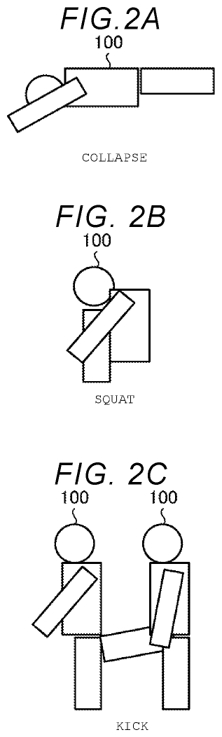

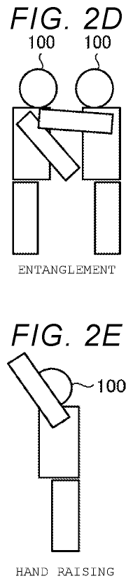

FIG. 1 shows an example of a functional configuration of an estimation device 1 of an embodiment. The estimation device 1 of the embodiment includes an imager 11, a detection unit 12, a conversion unit 13, an estimation unit 14, and an action DB 15. The estimation device 1 estimates an action (e.g., a specific action of a pedestrian as a subject) using, for example, the imager 11. A specific action is a predetermined action that can be determined from one image seen by a person, from examples such as “collapsing” (see FIG. 2A), “squatting” (see FIG. 2B), “kicking” (see FIG. 2C), “entangling with another one” (see FIG. 2D), and “raising hand” (see FIG. 2E), for example, but may also be extended to any action other than the actions illustrated herein.

The imager 11 is not an imaging device capable of acquiring a depth such as a stereo camera, and a LiDAR, but a general visible light monocular camera. Further, the imager 11 may be a special imaging device, but captures a still image as an image.

The imager 11 can be, for example, a fixed security camera. The fixed security camera refers to a security camera fixed at its physical installation position. The imager 11 may have a variable shooting range as in a pan-tilt camera, as long as an angle between an optical axis of the camera and the subject, e.g., pedestrian, which will be described later, are known.

The detection unit 12 image processes an image from the imager 11 and detects skeleton information from an image. The skeleton information is predetermined feature points (e.g., a crown, elbows, shoulders, a waist, knees, hands and feet, etc.) of a subject (e.g., a person 100). The skeleton information is, for example, a two-dimensional coordinate sequence indicating positions of a crown, elbows, shoulders, a waist, knees, hands and feet, and the like. When a positional relation between the person 100 and the imager 11 is known, an action of the person 100 can be estimated from the two-dimensional coordinate sequence showing the skeleton information. As a method for detecting skeleton information from an image (pose estimation), for example, the method disclosed in Z. Cao, et al., Realtime Multi-Person 2D Pose Estimation using Part Affinity Fields, in CVPR 2017 may be used.

The conversion unit 13 converts a coordinate system representing the skeleton information into a coordinate system normalized in a rectangle including the person 100. For example, the conversion unit 13 converts two-dimensional coordinates in image coordinates detected by the detection unit 12 into normalized coordinate values based on a circumscribed rectangle of a subject person. Since the scale changes according to a distance between the imager 11 and the person 100, the conversion unit 13 normalizes the coordinates with the circumscribed rectangle of the person 100. Specifically, the scale may be normalized so that the center of the crown and the center of the waist are at specific positions, and the scale may be normalized by lengths between two points (e.g., a length of the whole body from the crown to the feet and a length of a spine from the shoulder to the waist). For example, the rotation, translation, and scale are estimated and normalized so that the center point of the crown is (X, Y)=(0.5, 0.1) and the center point of the waist is (X, Y)=(0.5, 0.5). As described above, the conversion unit 13 normalizes the coordinates so that, for example, only the center of the crown and the center of the waist are the same position.

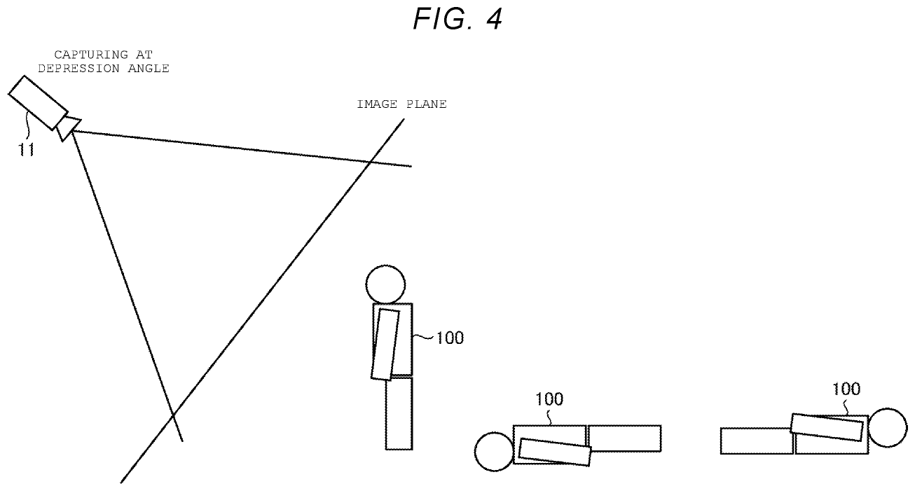

FIG. 4 is a view showing an example of a person in an upright posture, a person collapsing in the direction of the camera, and a person collapsing in the opposite direction of the camera. When normalizing the coordinates, as described above, the center point of the crown is normalized so that (X, Y)=(0.5, 0.1) and the center point of the waist is normalized so that (X, Y)=(0.5, 0.5). Thus, a person whose head collapses in the direction of the camera positioned below the waist in the image can be estimated in the same way as a person whose head collapses in the opposite direction of the camera positioned above the waist in the image.

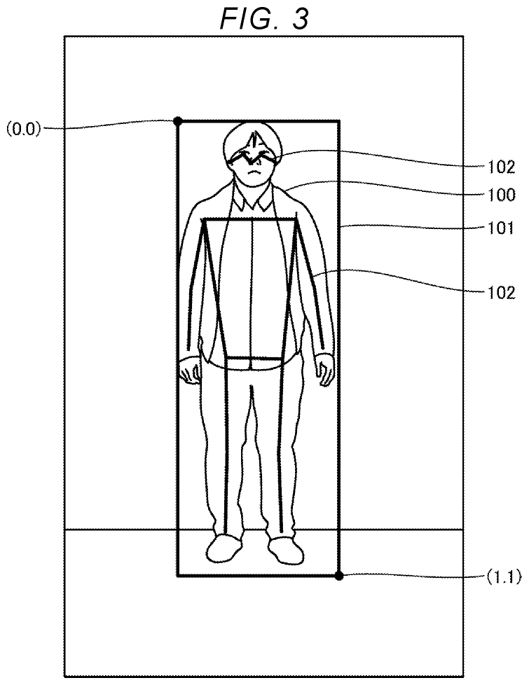

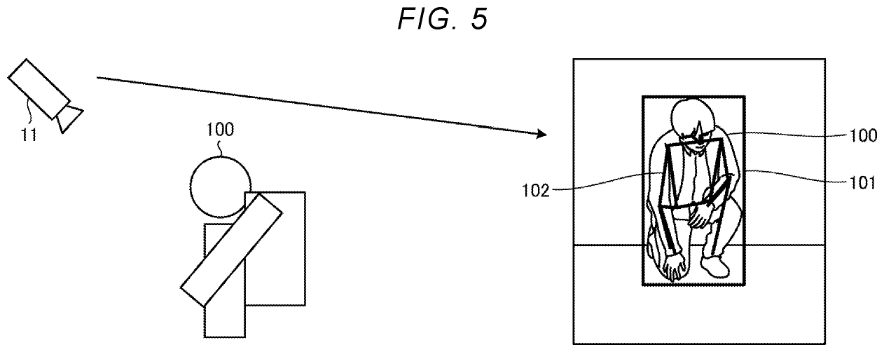

FIG. 3 is a view showing an example of a coordinate system converted by the conversion unit 13 of the embodiment. Specifically, the conversion unit 13 converts skeleton information 102 on a subject person into a coordinate system (x, y) in which the upper left position of a circumscribed rectangle 101 of each person is the origin (x, y)=(0, 0), and the lower right position is (x, y)=(1, 1) (see FIG. 3). Since this process is performed only for a detected subject person, a subsequent process is not performed when a subject person cannot be detected in an image. FIG. 5 is a view showing an example of an image of a squatting person captured by camera. Similarly, the skeleton information is detected from the image by the detection unit 12 in this embodiment.

Referring again to FIG. 1, the estimation unit 14 estimates whether an action is a predetermined specific action using the coordinate-converted skeleton information of each subject person acquired by the conversion unit 13. In a case of estimating an action only from skeleton information shown in the two-dimensional coordinate sequence, the original three-dimensional coordinate information is degenerated depending on a camera angle at which the person 100 is captured, so different actions may look like the same action. Therefore, skeleton information on a specific action determined in advance is information obtained by analyzing an image acquired by the imager 11 used at the time of estimation. In the following, the coordinate-converted skeleton information is simply referred to as skeleton information.

Here, when the imager 11 acquires an image with a camera that captures a wide range with a wide-angle lens such as a fisheye camera installed on a ceiling, an appearance of a person differs at the center of the image and the circumference of the image. Thus, the image is divided into regions, and different skeleton information is determined and estimated in each region.

In addition, when the imager 11 is a pan-tilt camera, the camera's three-axis rotation (horizontal, vertical, roll) is acquired by using a sensor value of the camera or using pre-registered surrounding image information to determine which region of the surrounding environment is being captured, and determine and estimate different skeleton information for each region.

Next, a specific action estimation method will be described. For the sake of simplicity, the following description will be made using an image acquired by the imager 11 installed at an angle close to horizontal.

The action estimation method is divided into a statistical estimation method and a rule-based estimation method.

In the case of the statistical action estimation method, first, the estimation unit 14 generates a multidimensional vector by connecting coordinate values of the skeleton information (e.g., coordinate values of elbows, shoulders, a waist, knees, etc.). Next, the estimation unit 14 estimates an action by a subspace method. In the subspace method, a subspace is calculated from a multidimensional vector of a person who has performed a specific action to calculate a first canonical angle or a projection length of the multidimensional vector of the person to be estimated with the subspace of each action. Then, for the specific action with the closest first canonical angle or projection length, when the first canonical angle or projection length is within a preset threshold value, it is estimated that the specific action is performed.

Further, the action estimation method used in the estimation unit 14 may be a method other than the subspace method. The estimation unit 14 may use, for example, a nearest neighbor classifier, a support vector machine (SVM), or the like. Also, for example, the estimation unit 14 may estimate an action using a convolutional neural network.

When the rule-based estimation method is used, the estimation unit 14 estimates a specific action based on an amount of change in the position of a key feature point for distinguishing the specific action. A starting point of the amount of change is, for example, the position of the feature point during normal upright walking (upright posture). For example, the estimation unit 14 selects two points determined for each specific action from a feature point in a rectangle (the circumscribed rectangle 101 in the embodiment), and determines a ratio of a length between the two points to a length of a side of the rectangle as a threshold value.

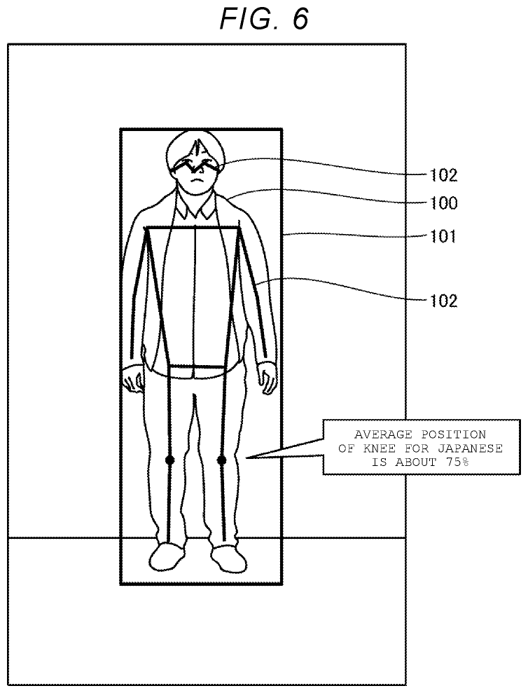

FIG. 6 is a view showing an example of key feature points (in case of knees positions) used for estimation of the embodiment. The example of FIG. 6 shows a case that the imager 11 captures an image from the same line-of-sight height as the person 100. For example, a key feature point for distinguishing a collapse and a squat is a feature point indicating the positions of knees (coordinates indicating the center of both knees) among the feature points included in the skeleton information 102. In a case of the collapse and squat, a value of the y-axis coordinate in the coordinates indicating the center of both knees is smaller than a value of the y-axis coordinate in the coordinates indicating the center of both knees during upright walking. Specifically, it is around 0.75 at normal times (during upright walking) (see FIG. 6), while a value of 0.5 to 0.6 is taken during the collapse and squat. This is because a y-axis direction of the circumscribed rectangle 101 of the person becomes narrower due to the collapse or squat to decrease a y-coordinate value of the center of both knees after normalization.

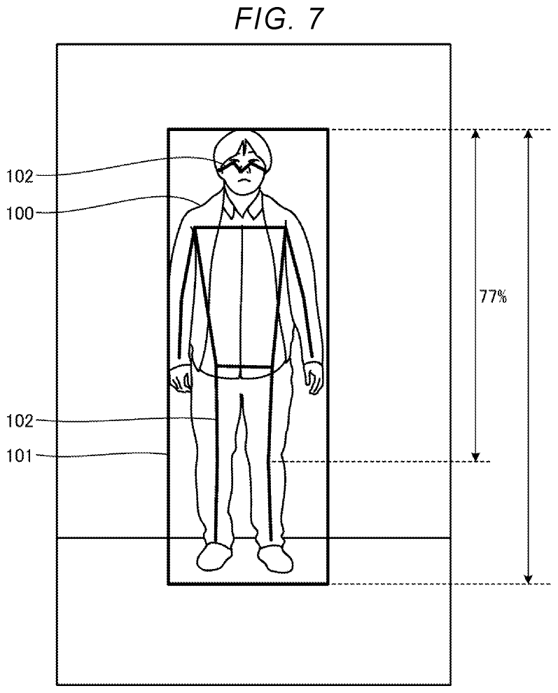

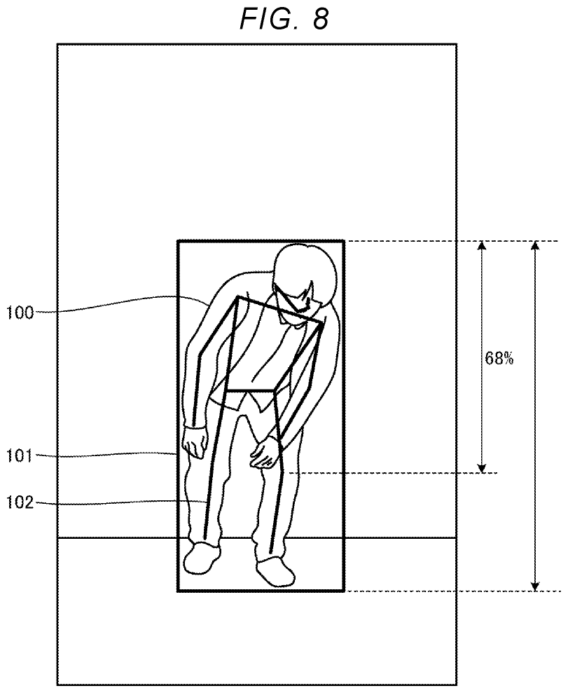

FIG. 7 is a view showing an Example 1 (in a case of an upright posture) of a ratio of a length from y=0 to the position of the y-coordinate of a knee to a length of the entire y-axis of the embodiment. The example of FIG. 7 shows a case that a length from y=0 to the position of the y-coordinate of a knee of the person 100 occupies 77% of the length of the entire y-axis (a length of a vertical side of the circumscribed rectangle 101).

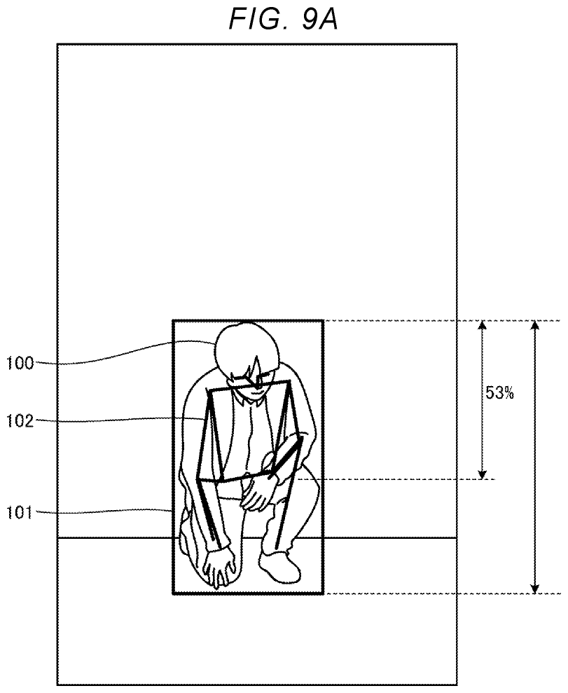

FIG. 8 is a view showing an Example 2 (in a case of a squat) of a ratio of a length from y=0 to the position of the y-coordinate of a knee to a length of the entire y-axis of the embodiment. The example of FIG. 8 shows a case that a length from y=0 to the position of the y-coordinate of a knee of the person 100 occupies 68% of the length of the entire y-axis.

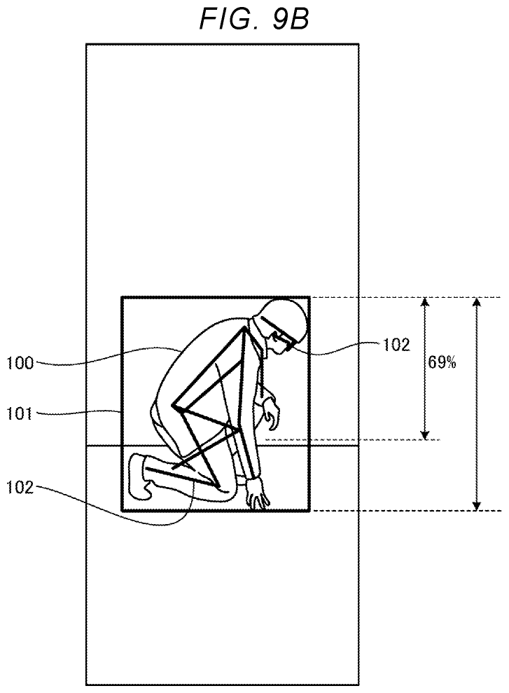

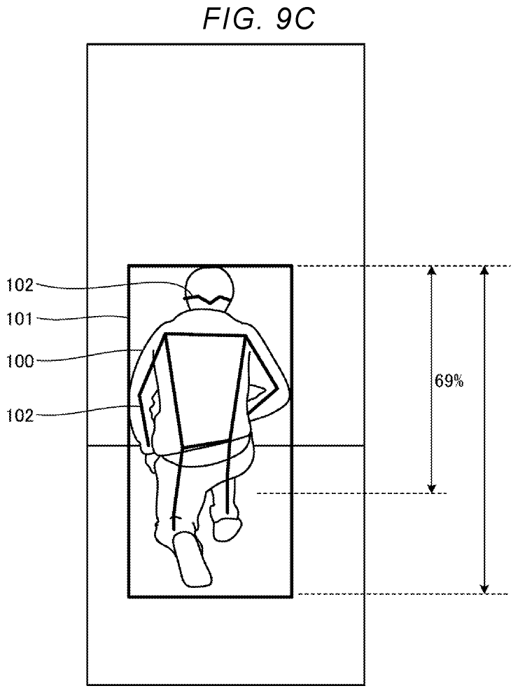

FIG. 9A is a view showing an Example 3 (in a case of a crouch) of a ratio of a length from y=0 to the position of the y-coordinate of a knee to a length of the entire y-axis of the embodiment. The example of FIG. 9A shows a case that a length from y=0 to the position of the y-coordinate of a knee of the person 100 occupies 53% of the length of the entire y-axis.

FIG. 9B is a view showing an Example 4 (in a case of a crouch) of a ratio of a length from y=0 to the position of the y-coordinate of a knee to a length of the entire y-axis of the embodiment. The example of FIG. 9B shows a case that a length from y=0 to the position of the y-coordinate of a knee of the person 100 occupies 69% of the length of the entire y-axis.

FIG. 9C is a view showing an Example 5 (in a case of a crouch) of a ratio of a length from y=0 to the position of the y-coordinate of a knee to a length of the entire y-axis of the embodiment. The example of FIG. 9C shows a case that a length from y=0 to the position of the y-coordinate of a knee of the person 100 occupies 69% of the length of the entire y-axis.

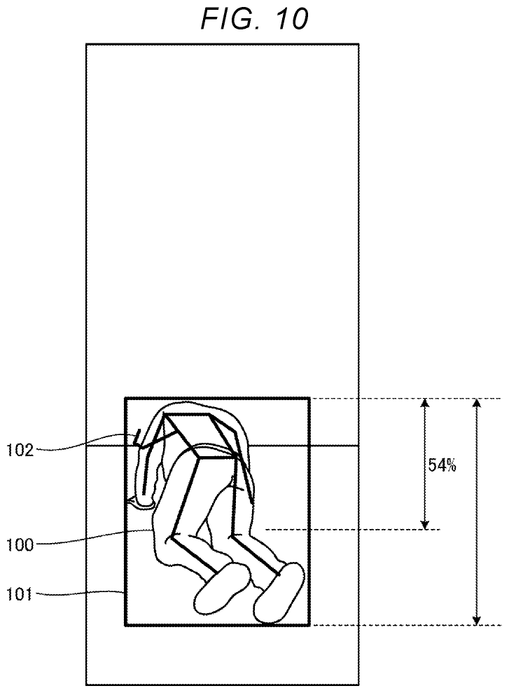

FIG. 10 is a view showing an Example 6 (in a case of a collapse) of a ratio of a length from y=0 to the position of the y-coordinate of a knee to a length of the entire y-axis of the embodiment. The example of FIG. 10 shows a case that a length from y=0 to the position of the y-coordinate of a knee of the person 100 occupies 54% of the length of the entire y-axis.

A key feature point for distinguishing a specific action is different for each specific action.

For example, in an action of raising a hand (see FIG. 2E), since one hand of the person 100 is raised, either one of the coordinates of the tips of both hands changes to a very small value or a negative value.

In addition, for example, in a case of a kicking action (see FIG. 2C), since one leg of the person 100 is raised, either one of the y-coordinates of both knees changes to a value smaller than the y-coordinate value of the knee at normal times.

Moreover, for example, in a case of an action of entanglement with another person (see FIG. 2D), with respect to two persons 100 present in close distance, the y-coordinate value of a knee changes to a value smaller than the y-coordinate value of the knee at normal to times, and the y-coordinate value of the tip of a hand also changes to a value smaller than the y-coordinate value of the tip of the hand at normal times.

As described above, for a specific action, the estimation unit 14 determines in advance how the position of a specific portion changes to be the specific action, and estimates the specific action according to the rule.

The action DB 15 stores a statistical model of each action when the estimation unit 14 uses a statistical estimation method, and stores the rule when the estimation unit 14 uses a rule-based estimation method. When performing an estimation process, the estimation unit 14 takes out information stored in the action DB 15 in advance and uses the information for the estimation.

When the estimation unit 14 performs machine learning-based action estimation (recognition) based on a similarity with a pre-registered action, skeleton information on a person is extracted from an image using a feature point detection technique (see e.g., Zhe Cao, Thomas Simon, Shih-En Wei, Yaser Sheikh, Realtime Multi-Person 2D Pose Estimation using Part Affinity Fields, retrieved on Oct. 19, 2020 from the Internet <URL: https://arxiv.org/pdf/1611.08050.pdf>, etc.). The estimation unit 14 may calculate a similarity of an action according to a detection score of each of the detected feature points, that is, a likelihood (certainty). In this case, for example, the detection unit 12 calculates a detection score indicating a likelihood of a feature point (first feature point) detected from the image. Then, the estimation unit 14 assigns a weight based on the detection score to the feature point, and determines a position of the feature point at which the weight is larger than a threshold value (second threshold value) as a threshold value (first threshold value), thereby estimating an action of the person 100. Also, the estimation unit 14 determines a degree of similarity between one or more first feature points and one or more second feature points indicating a feature of a specific action by a weighted sum of weights, and estimates that the person 100 is performing a specific action when the degree of similarity is smaller than the threshold value (first threshold value).

Specifically, when the number of feature points is n, the skeleton information is expressed as a 2n-dimensional vector. As described in the above-mentioned subspace method, the estimation unit 14 projects skeleton information onto a d-dimensional subspace suitable for identifying an action, and calculates a similarity according to a distance in the subspace. Since the detection score of each feature point is an n-dimensional vector, the detection scores of the x- and y-coordinates are treated as the same, and the detection score is projected onto the d-dimensional subspace as in the case of the skeleton information. The to estimation unit 14 may use the detection score as a weight vector, and use the weight vector when calculating the similarity of feature points, thereby reducing a weight of unreliable feature point information. As a result, the estimation unit 14 improves identification accuracy.

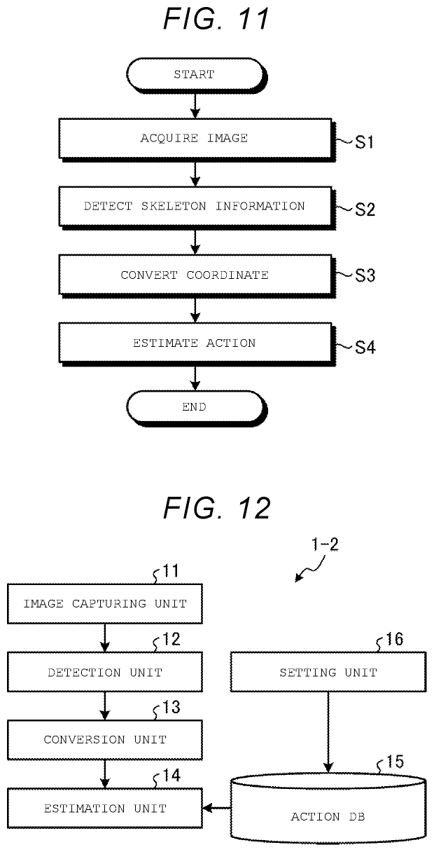

FIG. 11 is a flowchart showing an example of an estimation method of the embodiment. First, the imager 11 captures an image including the person or subject 100 (step S1). Next, the detection unit 12 detects skeleton information from the image captured by the process of step S1 (step S2).

Next, the estimation device 1 executes the processes of steps S3 and S4 for each person or subject for the number of persons or subjects 100 whose skeleton information is detected by the process of step S2. Further, the estimation device 1 does not execute the processes of steps S3 and S4 when the skeleton information is not detected in the process of step S2.

The conversion unit 13 converts the coordinate system representing the skeleton information into a coordinate system normalized based on the circumscribed rectangle 101 of the person or subject 100 (step S3). Next, the estimation unit 14 estimates a specific action using the skeleton information converted by the process of step S3 and the information stored in the above-mentioned action DB 15 (step S4). When it is determined to correspond to a specific action, information indicating the specific action is output from the estimation device 1.

As described above, in the estimation device 1 of a first embodiment, the imager 11 captures an image including a subject (the person 100 in the embodiment). The detection unit 12 detects skeleton information including a feature point (first feature point) indicating the skeleton of the person or subject 100 from the image. The estimation unit 14 estimates an action of the person or subject 100 by determining a position of the first feature point within a rectangle (the circumscribed rectangle 101 in the embodiment) including the person or subject 100 as a threshold value (first threshold value) based on an installation position of the image capturing unit 11 and an imaging range of the image capturing unit 11.

As a result, according to the estimation device 1 of the first embodiment, the action of the subject (the person 100 in the embodiment) can be estimated from less information. According to the estimation device 1 of the first embodiment, it is possible to estimate an action from one still image. In the related art, to estimate the action of the person 100, a sensor capable of acquiring a depth, an imaging device that captures a high frame rate video, or the like is required. In an actual usage scene, an application such as monitoring an action of a person with a security camera may be taken into consideration, but additionally installing a sensor capable of acquiring a depth will increase cost. Moreover, the security camera may typically acquire only a video having a low frame rate of about 5 fps. According to the estimation device 1 of the first embodiment, the action of the person 100 can be estimated at a lower cost.

Next, a modification example of the embodiment will be described. In the description of the modification example, the same description as in the embodiment will be omitted.

In an estimation process of each specific action executed by the estimation unit 14 of the above-described embodiment, a threshold value is used in both the statistical estimation method and the rule-based estimation method. This threshold value may be set in the action DB 15 as a fixed value in advance, but an appropriate threshold value differs depending on an installation environment of the imager 11. Therefore, in the modification example, a case of further including a setting unit that sets the threshold value to a more appropriate value will be described.

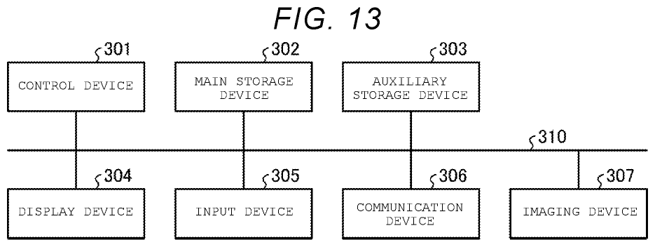

FIG. 12 is a view showing an example of a functional configuration of an estimation device 1-2 of the modification example of the embodiment. The estimation device 1-2 of the modification example includes the imager 11, the detection unit 12, the conversion unit 13, the estimation unit 14, the action DB 15, and a setting unit 16. The setting unit 16 may be implemented as an external device of the estimation device 1.

The setting unit 16 calculates a threshold value used for estimating each specific action, and sets the threshold value in the action DB 15.

For example, when the installation position of the imager 11 is a position where the person 100 is captured at a depression angle, the setting unit 16 sets a threshold value (first threshold value) based on a height of the installation position, and the depression angle.

Also, for example, when receiving input information indicating the installation height of the imager 11 (e.g. a camera) from the floor plane, lens information, and an optical axis direction, the setting unit 16 automatically sets the threshold value used for estimating each specific action. Specifically, when the input information is received, the setting unit 16 estimates how a person who normally walks appears on an image acquired by the imager 11, using, for example, a standard skeleton of a person with a height of 170 cm, and calculates a threshold value used for estimating each specific action, and sets the threshold value.

In addition, for example, the setting unit 16 receives an input of a video showing a state of the person 100 who normally walks upright, and sets a threshold value (first threshold to value) from the appearance of the person seen in a frame included in the video. Specifically, for example, the setting unit 16 includes a registration mode, and the imager 11 captures a state of normal walking as a video, and the setting unit 16 automatically sets a threshold value from an appearance of a person who normally walks seen in each frame of the video while operating in the registration mode.

Moreover, when an appearance of a person who normally walks differs greatly according to a position on the image, and the suitable threshold value differs greatly, the setting unit 16 may divide the image into a plurality of regions to set or automatically set a threshold value for each region. For example, in case of a camera in which the imager 11 is installed at an angle close to vertical, the appearance of the person 100 differs greatly between the center of the image and an edge of the image, so a ratio of a length from the crown to the knee with respect to a length of the whole body is very different. Therefore, the setting unit 16 may divide the image into a plurality of regions to receive an input of a threshold value for each region. Besides the setting unit 16 may automatically divide the image into a grid shape to automatically set a threshold value in each grid, and automate region division and threshold value setting by the process of integration when adjacent grids have a similar threshold value.

FIG. 13 is a view showing an example of a hardware configuration of the estimation device 1 of the embodiment. The estimation device 1 of the embodiment includes a control device 301, a main storage device 302, an auxiliary storage device 303, a display device 304, an input device 305, a communication device 306, and an imaging device 307. The control device 301, the main storage device 302, the auxiliary storage device 303, the display device 304, the input device 305, the communication device 306, and the imaging device 307 are connected via a bus 310.

The control device 301 is a processor or computer system forming the detection unit 12, conversion unit 13, estimation unit 13, and setting unit 16 and executes a program read from the auxiliary storage device 303 to the main storage device 302. The main storage device 302 is a memory such as a read only memory (ROM) and a random access memory (RAM). The auxiliary storage device 303 is a hard disk drive (HDD), a memory card, or the like.

The display device 304 displays display information. The display device 304 is, for example, a liquid crystal display or the like. The input device 305 is an interface for operating the estimation device 1. The input device 305 is, for example, a keyboard, a mouse, or the like. The communication device 306 is an interface for communicating with another device. Further, the estimation device 1 may not include the display device 304 and the input device 305. When the estimation device 1 does not include the display device 304 and the input device 305, setting or the like of the estimation device 1 is performed from another device via, for example, the communication device 306.

The program executed by the estimation device 1 of the embodiment is provided as a computer program product that is recorded on a computer-readable storage medium such as a CD-ROM, a memory card, a CD-R, or a digital versatile disc (DVD) in a file with an installable or executable format.

In addition, the program executed by the estimation device 1 of the embodiment may be stored on a computer connected to a network such as the Internet and provided by downloading through the network. Moreover, the program executed by the estimation device 1 of the embodiment may be provided through a network such as the Internet without being downloaded.

Besides, the program of the estimation device 1 of the embodiment may be provided by being incorporating into a ROM or the like in advance.

The program executed by the estimation device 1 of the embodiment is a module having a functional block that can be implemented by the program among the above-mentioned functional blocks. As for each of the functional blocks, as the control device 301 reads the program from the storage medium and executes it as actual hardware, each of the above functional blocks is loaded on the main storage device 302. That is, each of the above functional blocks is generated on the main storage device 302.

Part or all of the above-described functional blocks may be implemented by hardware such as an integrated circuit (IC) instead of being implemented by software.

In addition, when respective functions are implemented using a plurality of processors, each processor may implement one of the respective functions, or may implement two or more of the respective functions.

Moreover, the operation mode of the estimation device 1 of the embodiment may be in any mode. Part of functions of the estimation device 1 of the embodiment (e.g., the detection unit 12, the conversion unit 13, the estimation unit 14, the setting unit 16, etc.) may be operated as, for example, a cloud system on a network. Besides, the estimation device 1 of the embodiment may be operated as an estimation system configured with a plurality of devices (e.g., an estimation system configured with the imaging device 307 and a computer, etc.).

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

1. An estimation device comprising:
an imager that captures a still image of a subject;
a processor configured to function as:
a detection unit that detects skeleton information including a first feature point indicating a skeleton of the subject from the image; and
an estimation unit that estimates an action of the subject by determining a position of the first feature point in a rectangle including the subject as a first threshold value based on an installation position of the imager and an imaging range of the image.

2. The estimation device according to claim 1, the processor further configured to function as:
a conversion unit that converts a coordinate system representing the skeleton information into a normalized coordinate system normalized in the rectangle, wherein
the estimation unit estimates the action of the subject by determining the position of the first feature point represented by the normalized coordinate system as the first threshold value.

3. The estimation device according to claim 1, wherein
the estimation unit estimates the action of the subject by selecting two points determined for each specific action from the first feature point in the rectangle, and determines a ratio of a length between the two points to a length of a side of the rectangle as the first threshold value.

4. The estimation device according to claim 1, wherein
the detection unit calculates a detection score indicating a likelihood of the first feature point detected from the image, and
the estimation unit estimates the action of the subject by assigning a weight based on the detection score to the first feature point, and determines a position of a first feature point at which the weight is larger than a second threshold value as the first threshold value.

5. The estimation device according to claim 4, wherein
the estimation unit determines a degree of similarity between one or more first feature points and one or more second feature points indicating a feature of a specific action by a weighted sum of the weights, and estimates that the subject is performing the specific action when the degree of similarity is smaller than the first threshold value.

6. The estimation device according to claim 1, wherein
the skeleton information includes at least one of a crown, elbows, shoulders, a waist, knees, hands, or feet of the subject.

7. The estimation device according to claim 1, wherein
the installation position of the imager is a position where the subject is captured at a depression angle, and
the processor is further configured to function as:
a setting unit that sets the first threshold value based on a height of the installation position and the depression angle.

8. The estimation device according to claim 1, the processor is further configured to function as:
a setting unit that receives an input of a video showing a state of a subject who normally walks upright, and sets the first threshold value from an appearance of the subject seen in a frame included in the video.

9. An estimation method comprising:
capturing, by an imager, a still image including a subject;
detecting, by a processor implemented detection unit, skeleton information including a first feature point indicating a skeleton of the subject from the image; and
estimating, by a processor implemented estimation unit, an action of the subject by determining a position of the first feature point in a rectangle including the subject as a first threshold value based on an installation position of the imager and an imaging range of the imager.

10. The estimation method according to claim 9, further comprising:
converting, by a processor implemented conversion unit, a coordinate system representing the skeleton information into a normalized coordinate system normalized in the rectangle, and
the estimating estimates the action of the subject by determining the position of the first feature point represented by the normalized coordinate system as the first threshold value.

11. The estimation method according to claim 9, wherein
the estimating estimates the action of the subject by selecting two points determined for each specific action from the first feature point in the rectangle, and determining a ratio of a length between the two points to a length of a side of the rectangle as the first threshold value.

12. The estimation method according to claim 9, wherein
the detecting calculates a detection score indicating a likelihood of the first feature point detected from the image, and
the estimating estimates the action of the subject by assigning a weight based on the detection score to the first feature point, and determines a position of a first feature point at which the weight is larger than a second threshold value as the first threshold value.

13. The estimation method according to claim 12, wherein
the estimating determines a degree of similarity between one or more first feature points and one or more second feature points indicating a feature of a specific action by a weighted sum of the weights, and estimates that the subject is performing the specific action when the degree of similarity is smaller than the first threshold value.

14. The estimation method according to claim 9, wherein
the skeleton information includes at least one of a crown, elbows, shoulders, a waist, knees, hands, or feet of the subject.

15. The estimation method according to claim 9, wherein
the installation position of the imager is a position where the subject is captured at a depression angle, and
further comprising:
setting, by a processor implemented setting unit, the first threshold value based on a height of the installation position and the depression angle.

16. The estimation method according to claim 9, further comprising:
receiving, by a processor implemented setting unit, an input of a video showing a state of a subject who normally walks upright, and setting the first threshold value from an appearance of the subject seen in a frame included in the video.

17. A non-transitory computer readable medium including a program for causing a computer connected to an imager that captures a still image including a subject, to function as:
a detection unit that detects skeleton information including a first feature point indicating a skeleton of the subject from the image; and
an estimation unit that estimates an action of the subject by determining a position of the first feature point in a rectangle including the subject as a first threshold value based on an installation position of the imager and an imaging range of the imager.
